(19) United States
(12) Patent Application Publication
(10) Pub. No.: US 2006/0137558 A1
(43) Pub. Date: Jun. 29, 2006

(54) Method for transfer-printing patterns

(75) Inventor: Chi-Chan Lin, Taipei City (TW)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: HANNSPREE, INC., Taipei (TW)

(21) Appl. No.: 11/081,716

(22) Filed: Mar. 17, 2005

(30) Foreign Application Priority Data
Dec. 24, 2004 (TW) 093140540

(51) Int. Cl. B41F 3/34

(52) U.S. Cl. 101/492

(57) ABSTRACT

A method for transfer-printing is disclosed. The method includes the following steps: (a) providing both a transfer-printing film and a substrate; (b) mask-spraying the surface of the substrate to form a plurality of first bands and plurality of second bands; and (c) transferring the pattern on the transfer-printing film onto the substrate having a plurality of first bands and plurality of second bands. The accuracy of the alignment of the pattern to the substrate can be improved through using the present invention method without complicated procedures. Moreover, the visual image of the pattern appears to align regularly. The method disclosed here can be applied to planar surfaces, curved surfaces, and discontinuous surfaces.

### BACKGROUND OF THE INVENTION

1. Field of the Invention

The present invention relates to a method for transfer-printing patterns and more particularly, to a method for transfer-printing patterns with a simplified pattern alignment process.

2. Description of the Related Art

Transfer-printing methods primarily utilize water pressure and activators to dissolve varnish from a transfer-printing film, which can be of two different technology types: the first is a watermark transfer technology, and the other is a cubic transfer technology. The first technology is used for transferring text and graphics, while the second technology is used to transfer a pattern on to an entire product surface.

Cubic transfer technology utilizes a water-dissolvable film to carry the patterns. The film is provided with an excellent tensile strength for wrapping around the product surface, and so it easily covers the entire product to impart a different appearance. Cubic transfer technology can be performed upon objects with any shape, and is a solution for three-dimensional printing. The transfer film can have different patterns, such as a wood pattern, a leather pattern, a jade pattern or a marble pattern. Furthermore, during the transfer process, there is no contact between the product surface and the printing film, which avoids damage to the product surface.

However, during a transfer-printing process, it is not easy to place a particular pattern within a particular region because the pattern may sometimes not align with the region. This is particularly true when a parallel pattern must be transferred onto a frame; each line in the pattern needs to be transferred on to the frame individually, but sometimes the formed pattern is not parallel with the edges of the frame. Therefore, the prior art technologies work better with irregular, continuous patterns, and also require multiple processes.

Therefore, it is desirable to provide a transfer-printing method for patterns to mitigate and/or obviate the aforementioned problems.

### SUMMARY OF THE INVENTION

A main objective of the present invention is to provide a method for the transfer-printing of patterns, which performs a mask-spray process to form regions with different color densities to aid in alignment for the transfer-printing process. Accuracy of the alignment of the pattern with a substrate is improved by using the present invention method, without the need for complicated procedures. Moreover, the visual image of the pattern can be aligned in what appears a regular manner. The method disclosed here can be applied on planar surfaces, curved surfaces, and discontinuous surfaces.

A method for transferring-printing patterns in accordance with the present invention comprises steps as follows: (a) providing both a transfer-printing film with a pattern, and a substrate; (b) mask-spraying a surface of the substrate to form a plurality of first bands, and a plurality of second bands with a different optical density from the first bands; and (c) transferring the pattern on the transfer-printing film onto the substrate having the plurality of first bands and the plurality of second bands.

The accuracy of the alignment of the pattern with the substrate is improved through the use of the present invention method without the need for complicated procedure. However, the present invention method may further comprise another step (a1): aligning the substrate and the transfer-printing film. The present invention can be applied to the transferring of patterns that require no alignment, but is preferably used for the transferring of patterns that require accurate alignment.

The first bands and the second bands can be arranged in any sequence; however, to have clear patterns and easy alignment, the first bands and the second bands should be arranged in an alternating manner. Furthermore, the first bands and the second bands can be any color, or of any optical density, but should not be identical to each other.

The first bands and the second bands can be regular or irregular stripes, but parallel regular stripes are preferred. The first bands and the second bands can have any lengths or widths, but it is preferred that they have the same width. Furthermore, a circumference of the first bands and the second bands should be parallel with an edge of the substrate.

The transfer-printing film is a semi-transparent film so that the color band formed on the substrate can still be shown. The transfer-printing film can have textual or graphical, regular or irregular, patterns, but preferably has a continuous irregular pattern, such as a wood pattern, a leather pattern, a jade pattern or a marble pattern. The substrate of the method can be of any shape, size, or material, and the method can be applied on planar surfaces, curved surfaces, and discontinuous surfaces, but is preferably used on a frame.

Other objects, advantages, and novel features of the invention will become more apparent from the following detailed description when taken in conjunction with the accompanying drawings.

### BRIEF DESCRIPTION OF THE DRAWINGS

FIG. 1 is a schematic drawing of a transfer-printing apparatus.

FIG. 2 is a schematic drawing of a preferred embodiment of the present invention.

### DETAILED DESCRIPTION OF THE PREFERRED EMBODIMENT

The present invention utilizes, by way of example, an irregular wood pattern with transfer-printing to transfer a wood pattern with different color densities onto a frame. The present invention can be applied to prior art transfer-printing devices, and a visual image of the pattern can be aligned regularly on parallel frames.

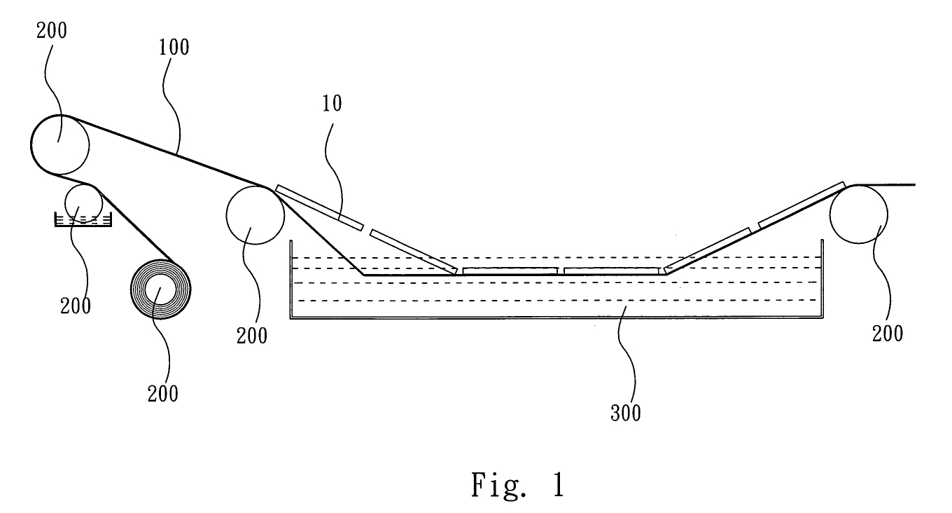

A prior art transfer-printing apparatus is shown in FIG. 1, and the present invention is applied to the prior art transfer-printing apparatus. The main characteristic of the present invention is that a substrate is processed with a “color-matching” process to display a clear pattern.

The prior art transfer-printing apparatus includes a plurality of rollers 200 for moving a handling belt 100, a transfer-printing tank 300 with water for floating the pattern of the transfer-printing film, and transfer-printing films (not shown). As shown in FIG. 1, a frame 10, or any substrate on the handling belt 100, can be moved into the transfer-printing tank 300 by the handling belt 100. When the frame 10 leaves the water in the transfer-printing tank 300, it carries the pattern on its surface to complete the pattern transferring process.

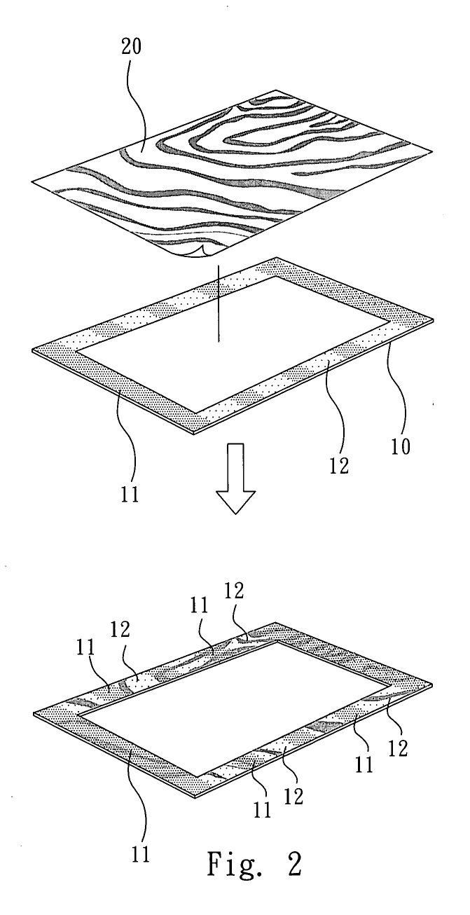

Please refer to FIG. 2. FIG. 2 is a schematic drawing of a preferred embodiment of the present invention. Before the pattern transferring process, a color matching process is performed to the frame 10. First, the frame 10 is completely coated with a lighter color to cover the original color of the frame 10. Next, a first predetermined pattern is sprayed on the coated frame 10, and in this embodiment, the first predetermined pattern is a plurality of darker color bands 11. Therefore, the plurality of darker color bands 11 and the lighter color coated frame form a parallel striped pattern having two different color densities. The plurality of darker color bands 11 and the plurality of lighter color bands 12 correspond to each other on the frame; in other words, the upper frame bar and the lower frame bar have the same color density sequence, as shown in FIG. 2(b).

The frame 10 with the plurality of darker color bands 11 and the plurality of lighter color bands 12 is placed on the handling belt 100 to be sent into the transfer-printing tank 300, where a second predetermined pattern is on the transfer-printing films floating on the water surface of the transfer-printing tank 300. In this embodiment, the transfer-printing film is a semi-transparent film with a wood pattern, and when the semi-transparent film with the wood pattern coats the frame 10 with the lighter color bands and darker color bands, a very obvious wood pattern with different color densities is formed on the frame 10. Since the darker color bands 11 and the lighter color bands 12 on the frame 10 are parallel to each other, the formed wood pattern will have a very distinguishable pattern, as shown in FIG. 2(c). Moreover, the second predetermined pattern can be any continuous irregular pattern, such as a leather pattern, a jade pattern, a marble pattern, etc.

Although the present invention has been explained in relation to its preferred embodiment, it is to be understood that many other possible modifications and variations can be made without departing from the spirit and scope of the invention as hereinafter claimed.

What is claimed is:

1. A method for transfer-printing patterns comprising:
(a) providing both a transfer-printing film with a pattern, and a substrate;
(b) mask-spraying a surface of said substrate to form a plurality of first bands, and a plurality of second bands with a different optical density from said first bands; and
(c) transferring the pattern on said transfer-printing film onto said substrate having the plurality of first bands and the plurality of second bands.

2. The method as claimed in claim 1, wherein a step (a1) is further comprised after said step (a), the step (a1) is: aligning the substrate and the transfer-printing film.

3. The method as claimed in claim 1, which is applied to accurate patterning.

4. The method as claimed in claim 1, wherein the plurality of first bands and the plurality of second bands have a color difference.

5. The method as claimed in claim 1, wherein the plurality of first bands and the plurality of second bands have the same color.

6. The method as claimed in claim 1, wherein the plurality of first bands and the plurality of second bands have the same width.

7. The method as claimed in claim 1, wherein the plurality of first bands and the plurality of second bands are parallel with an edge of the substrate.

8. The method as claimed in claim 1, wherein the pattern of the transfer-printing film is a continuous irregular pattern.

9. The method as claimed in claim 8, wherein the continuous irregular pattern is a wood pattern, a leather pattern, a jade pattern or a marble pattern.

10. The method as claimed in claim 1, wherein the substrate is a frame body.
